(19) United States
(12) Patent Application Publication
(10) Pub. No.: US 2026/0078139 A1
(43) Pub. Date: Mar. 19, 2026

(54) Nickel-Based Catalysts for the Selective (DE)Hydrogenative Coupling of Benzyl Alcohols with Azobenzenes

(71) Applicant: COUNCIL OF SCIENTIFIC AND INDUSTRIAL RESEARCH AN INDIAN REGISTERED BODY INCORPORATED UNDER THE, New Delhi (IN)

(72) Inventors: Benudhar PUNJI, Pune (IN); Sadhna BANSAL, Pune (IN)

(21) Appl. No.: 19/105,627

(22) PCT Filed: Aug. 23, 2023
(86) PCT No.: PCT/IN2023/050795

§ 371 Date: Feb. 21, 2025

(30) Foreign Application Priority Data
Aug. 23, 2022 (IN) 202211048083

(51) Int. Cl. C07F 15/04; B01J 31/18; B01J 37/02

(52) U.S. Cl. CPC C07F 15/045; B01J 31/1815; B01J 37/0236; B01J 2531/847

(57) ABSTRACT

The present disclosure discloses a nickel catalyst of formula (I). The present disclosure also discloses a process of hydrogenation-dehydrogenation coupling catalyzed by catalyst of formula (I). Further, the present disclosure also discloses a process for secondary imine hydrogenation reactions catalyzed by catalyst of formula (I).

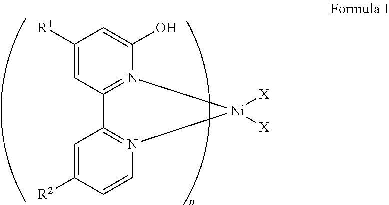

### FIELD OF THE INVENTION

The present disclosure relates to a nickel catalyst of formula (I).

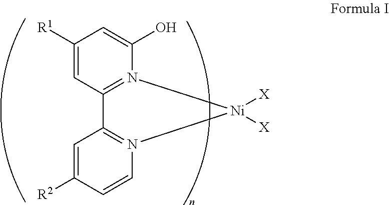

Particularly, present invention relates to the catalyst used for hydrogenation-dehydrogenation coupling reactions and for secondary imine hydrogenation reactions.

### BACKGROUND OF THE INVENTION

Generally, the construction of the carbon-nitrogen bond symbolizes a fundamental step in synthesizing complex molecular architectures relevant to the chemical industries and biological sciences. Several efficient and robust approaches are available to create C—N bonds, such as Buchwald-Hartwig amination, Ullmann reaction, Chan-Lam amination, and hydroamination. These methods are highly competent and extensively applied in academia and industries; however, they produce stoichiometric halide or metallic waste and/or use noble metal catalysts. Currently, the selective hydrogenative-dehydrogenative coupling of benzyl alcohols with azobenzene produces C—N bond containing compounds such as imines and amines, which are very essential as the resulted products have diverse applications, including intermediates in organic synthesis and dye industries. Most of the reported procedures include aniline (M. Vellakkaran et al., ACS Catal. 2017, 7, 8152-8158) and azide (H. Li et al., ACS Catal. 2021, 11, 4071-4076) as the starting material for N-containing compounds. Moreover, most of the catalysts used in these types of reactions require photocatalytic system (K Selvam et al., New J. Chem., 2015, 39, 2856-2860), heterogeneous system (Wang Feng et al., CN106608776A, 3 May 2017), expensive noble metals (Green Chem., 2019, 21, 219-224) and phosphine-based ligand systems (ACS Catal. 2021, 11, 4071-4076, J. Org. Chem. 2020, 85, 7125-7135). However, said most of the known catalysts and reactions are based on expensive transition metals and/or phosphine-based ligands and resulted with poor selectivities.

Hence, there is still need to provide new and better catalyst system for selective hydrogenative-dehydrogenative coupling reactions. Accordingly, present invention provides nitrogen-ligated phosphine-free nickel catalysts for the selective hydrogenative-dehydrogenative coupling of benzyl alcohols with azobenzene, which is highly sustainable considering the high abundance of nickel.

### OBJECTIVES OF THE INVENTION

Main objective of present invention is to provide nickel based catalyst of formula (I).

Another objective of the present invention is to provide nickel-based catalyst of formula (I) for hydrogenation-dehydrogenation coupling reactions and secondary imine hydrogenation reactions.

Yet another objective of the present invention is to provide a process of preparation of the nickel-based catalyst of formula I.

Yet another objective of the present invention is to provide processes of hydrogenation and/or dehydrogenation coupling reactions of benzyl alcohols with azobenzenes.

Still another objective of the present invention is to provide processes of hydrogenation and/or dehydrogenation coupling reactions of benzyl alcohols with azobenzenes using said nickel-based catalyst of formula (I).

### SUMMARY OF THE INVENTION

Accordingly, present invention provides a nickel-based catalyst of formula (I)

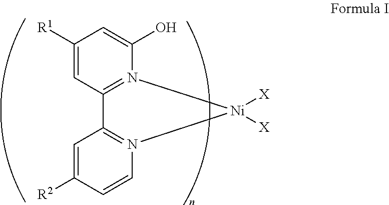

wherein,
n=1 or 2;
R¹ is selected from hydrogen, C1-C4 alkyl and aryl;
R² is selected from hydrogen, C1-C4 alkyl and aryl; and
X is selected from halogen, —OCO-alkyl, —OAc or —OTf;
wherein
the aryl of R¹ and/or R² is phenyl which may be further substituted with any of group selected from C1-C4 alkyl, aryl, alkoxy, halo, —OTf, —OCO-alkyl and —OAc;
the alkyl connected to —OCO— is C1-C4 alkyl; and
the halogen is selected from chloro, iodo, bromo and fluoro.

In an embodiment of the present invention, the catalyst is useful for hydrogenation-dehydrogenation coupling reactions and secondary imine hydrogenation reactions.

In another embodiment, present invention provides a process of preparation of nickel-based catalyst of formula (I) as claimed in claim 1 comprising steps of:
a) adding dimethoxy ethane nickel compound of formula II with hydroxy bipyridine compound of formula III in presence of a solvent under inert atmosphere in a round bottom glass flask to obtain a mixture;

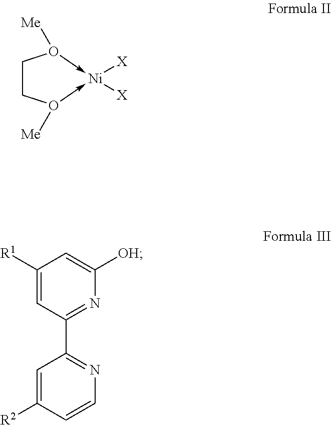

b) wherein the R¹, R² and X are same as defined in claim 1;
c) stirring the mixture as obtained in step a) at a temperature in the range of 25 to 60° C. for a time period of 12-24 hrs to obtain a stirred reaction mixture;
d) evaporating and drying the reaction mixture as obtained in step b) to obtain the catalyst of formula I; and
e) optionally, purifying the catalyst to obtain the catalyst of formula I.

In yet another embodiment of the present invention, the solvent used in step a) is selected from the group consisting of methanol, ethanol, toluene and THF. In yet another embodiment of the present invention, the evaporation and drying in step c) is done by first evaporating solvent in vacuo to obtain solid product, followed by washing with diethyl ether, and subsequent drying under vacuum provided the catalyst of formula I.

In yet another embodiment, present invention provides a process of hydrogenation-dehydrogenation coupling reaction using catalyst of formula (I) as claimed in claim 1, the process comprising steps of:
a) reacting azobenzene of formula IV with (un)substituted benzyl alcohol of formula V in presence of 0.001 to 0.05 mmol of the catalyst of formula (I) as claimed in claim 1, a base and a solvent in a tube to obtain a reaction mixture;

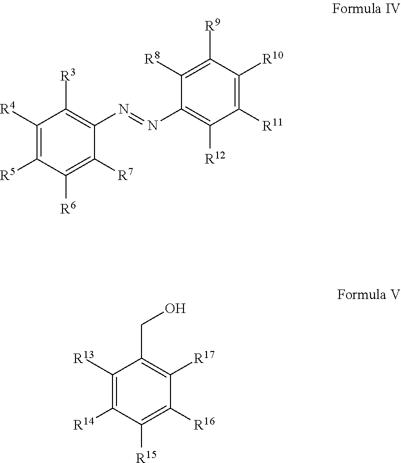

wherein
R3: hydrogen, alkyl, halogen and cycloalkyl;
R4: hydrogen, alkyl, alkoxy, halogen and cycloalkyl;
R5: hydrogen, alkyl, alkoxy, sulphonyl alkyl, —OCF3, —SMe, —SMe2, aminoalkyl, —CF3, —OCHF2, —COO-alkyl, halogen;
6: hydrogen, alkyl, alkoxy, and halogen;
R7: hydrogen, alkyl, halogen and cycloalkyl;
R8: hydrogen, alkyl, halogen and cycloalkyl;
R9: hydrogen, alkyl, alkoxy, halogen and cycloalkyl;
R10: hydrogen, alkyl, alkoxy, sulphonyl alkyl, aminoalkyl, amino, —CF3, —OCF3, —OCHF2, —COO-alkyl, halogen;
R11: hydrogen, alkyl, alkoxy, halogen and cycloalkyl;
R12: hydrogen, alkyl, halogen and cycloalkyl;
R13: hydrogen, alkyl, alkoxy, —CF3 and cycloalkyl;
R14: hydrogen, alkyl, alkoxy, —CF3, halogen and cycloalkyl;
R15: hydrogen, alkyl, alkoxy, sulphonyl alkyl, —O-aryl, —OCF3, —CF3, —SMe, —SMe2, halogen;
R16: hydrogen, alkyl, alkoxy, —CF3, halogen and cycloalkyl; and
R17: hydrogen, alkyl, alkoxy, —CF3 and cycloalkyl;
b) heating the reaction mixture obtained in step a) at a temperature in the range of 120-150° C. for a time period in the range of 16 to 24 h to obtain a hot reaction mixture; and
c) cooling the hot reaction mixture obtained in step b) to an ambient temperature in the range of 25-35° C. followed by filtration to obtain the (un)substituted of (E)-N,1-diphenylmethanimine compounds of Formula IIa and/or IIb

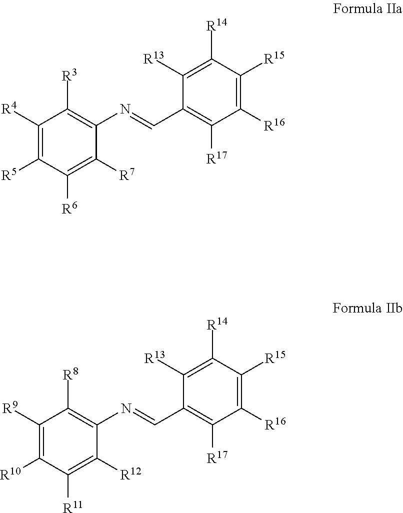

wherein R³, R⁴, R⁵, R⁶, R⁷, R⁸, R⁹, R¹⁰, R¹¹, R¹², R¹³, R¹⁴, R¹⁵, R¹⁶ and R¹⁷ is same as defined above, optionally R¹⁵ and R¹⁶ together forms a cyclic ring selected from aryl or heteroaryl ring.

In yet another embodiment of the present invention, the base is selected from the group consisting of potassium carbonate (K₂CO₃), potassium tertiary butoxide (KtOBu) and Tripotassium phosphate (K₃PO₄).

In yet another embodiment, present invention provides a process of secondary imine hydrogenation reaction using catalyst of formula (I) as claimed in claim 1, the process comprising steps of:
a) reacting azobenzene of formula IV with (un)substituted benzyl alcohol of formula V in presence of 0.001 to 0.05 mmol of the catalyst of formula (I) as claimed in claim 1, a base, and a solvent in a tube to obtain a reaction mixture;

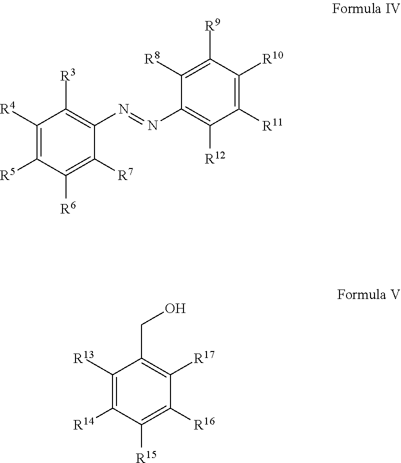

wherein
   R3: hydrogen, alkyl, halogen and cycloalkyl;
   R4: hydrogen, alkyl, alkoxy, halogen and cycloalkyl;
   R5: hydrogen, alkyl, alkoxy, sulphonyl alkyl, —OCF3, —SMe, —SMe2, aminoalkyl, —CF3, —OCHF2, —COO-alkyl, and halogen;
   R6: hydrogen, alkyl, alkoxy, halogen and cycloalkyl;
   R7 hydrogen, alkyl, halogen and cycloalkyl;
   R8: hydrogen, alkyl, halogen and cycloalkyl;
   R9: hydrogen, alkyl, alkoxy, halogen and cycloalkyl;
   R10: hydrogen, alkyl, alkoxy, sulphonyl alkyl, aminoalkyl, amino, —CF3, —OCF3, —OCHF2, —COO-alkyl, halogen;
   R11: hydrogen, alkyl, alkoxy, halogen and cycloalkyl;
   R12: hydrogen, alkyl, halogen and cycloalkyl;
   R13: hydrogen, alkyl, alkoxy, —CF3 and cycloalkyl;
   R14: hydrogen, alkyl, alkoxy, —CF3, halogen and cycloalkyl;
   R15: hydrogen, alkyl, alkoxy, sulphonyl alkyl, —O-aryl, —OCF3, —CF3, —SMe, —SMe2, and halogen;
   R16: hydrogen, alkyl, alkoxy, —CF3, halogen and cycloalkyl; and
   R17: hydrogen, alkyl, alkoxy, —CF3 and cycloalkyl;
b) heating the reaction mixture to a temperature in the range of 120-150° C. for a time period of 16-24 h to obtain a hot reaction mixture; and
c) cooling the hot reaction mixture as obtained in step (b) to room temperature in the range of 25-35° C. followed by filtration to obtain the (un)substituted N-benzylaniline of formula IIIa and/or IIIb

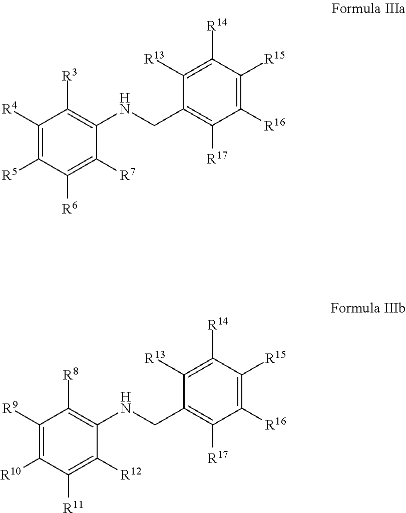

wherein R³, R⁴, R⁵, R⁶, R⁷, R⁸, R⁹, R¹⁰, R¹¹, R¹², R¹³, R¹⁴, R¹⁵, R¹⁶ and R¹⁷ is same as defined above, optionally R¹⁵ and R¹⁶ together forms a cyclic ring selected from aryl or heteroaryl ring.

In yet another embodiment of the present invention, the base is selected from potassium bis(trimethylsilyl)amide (KHMDS) and potassium tertiary butoxide (KtOBu).

In yet another embodiment of the present invention, in the compound of formulas IIa, IIb, IIIa, IIIb, IV and V, the alkyl is selected from C1-C6 alkyl; halogen is selected from chloro, bromo, fluoro and iodo; the alkyl in alkoxy, sulphonyl alkyl, aminoalkyl and —COO-alkyl groups is selected from C1-C4 alkyl; and the aryl in O-aryl is selected from substituted or unsubstituted aryl.

In yet another embodiment of the present invention, the solvent is selected from the group consisting of toluene, o-xylene, m-xylene and p-xylene.

In yet another embodiment, present invention provides a process of hydrogenation-dehydrogenation coupling reaction of azobenzene with (un)substituted benzyl alcohol in presence of the nickel based catalyst of formula (I), base and solvent at specific reaction conditions to obtain the (un)substituted (E)-N,1-diphenylmethanimine compounds.

In yet another embodiment, present invention provides a process of secondary imine hydrogenation reaction of azobenzene with (un)substituted benzyl alcohol in presence of the nickel based catalyst of formula (I), base and solvent to obtain (un)substituted N-benzylaniline compounds.

Accordingly, the present invention provides single nickel based catalyst which can act as dual catalyst providing two different products (imine and amine) with same reactants azobenzene and (un)substituted benzyl alcohol by tuning reaction conditions, and this dual selectivity of nickel is nowhere reported in the literature with such efficient yields.

### BRIEF DESCRIPTION OF THE DRAWINGS

FIG. 1 shows Thermal ellipsoid plot of Ni-2. Selected bond lengths (Å): Ni1-N1=2.135(2), Ni1-N2=2.069(2), Ni1-N3=2.059 (2), Ni1-N4=2.128 (2), Ni1-Cl1=2.4302 (6), Ni1-Cl2=2.430 (6). Selected bond angles (°): N4-Ni1-N1=171.11 (8), N3-Ni1-Cl1=178.81 (6), N2-Ni1-Cl2=177.78 (68), N2-Ni1-N1=79.06 (8), N2-Ni1-N4=94.15 (8), N3-Ni1-N1=94.89 (8), N4-Ni1-Cl1=99.61 (6).

FIG. 2 represents the synthetic scheme of compound of formula I.

FIG. 3 represents scope of various azoarenes to imines; wherein reaction conditions are as follow: 1 (0.20 mmol), 2a (0.044 g, 0.406 mmol), K₂CO₃ (0.028 g, 0.202 mmol), Ni-1 (0.003 g, 0.01 mmol, 5 mol %). Yields are determined by ¹H NMR analysis of crude reaction mixture. ^{a} Yield of isolated compound. ^{b} Product 3qa was not formed due to the low reactivity of the corresponding aniline.

FIG. 4 represents scope for the coupling of azobenzene with various benzyl alcohols to imines; wherein reaction conditions are as follow: 1a (0.037 g, 0.203 mmol), 2 (0.40 mmol), K₂CO₃ (0.028 g, 0.202 mmol), Ni-1 (0.003 g, 0.01 mmol, 5 mol %). Yields are determined by ¹H NMR analysis of crude reaction mixture.

FIG. 5 represents scope for the different azoarenes to amines; wherein reaction conditions are as follow: 1 (0.20 mmol), 2a (0.077, 0.71 mmol), KO^{t}Bu (0.034 g, 0.303 mmol), Ni-1 (0.003 g, 0.01 mmol, 5 mol %). Yields of isolated compound. ^{a} Yield by ¹H NMR analysis of crude reaction mixture.

FIG. 6 represents scope for coupling of azobenzene with various benzyl alcohols to amines; wherein reaction conditions are as follow: 1a (0.037 g, 0.203 mmol), 2 (0.71 mmol), KO^{t}Bu (0.034 g, 0.303 mmol), Ni-1 (0.003 g, 0.01 mmol, 5 mol %). Yields shown are of isolated compounds. ^{a} Yield by ¹H NMR analysis of crude reaction mixture.

### DETAILED DESCRIPTION OF THE INVENTION

The invention will now be described in detail in connection with certain preferred and optional embodiments, so that various aspects thereof may be more fully understood and appreciated.

“Alkyl” as used herein is collection of carbon atoms that are covalently linked together in normal, secondary, tertiary or cyclic arrangements, i.e., in linear, branched, cyclic arrangement or some combination thereof. An alkyl substituent to structure is chain of carbon atoms that is covalently attached to structure through sp³ carbon of substituent. The alkyl substituents, as used herein, contains one or more saturated moieties or groups and may additionally contain unsaturated alkyl moieties or groups, i.e., substituent may comprise one, two, three or more independently selected double bonds or triple bonds of combination thereof, typically one double or one triple bond if such unsaturated alkyl moieties or groups are present. Unsaturated alkyl moieties or groups include moieties or groups as described below for alkenyl, alkynyl, cycloalkyl, and aryl moieties. Saturated alkyl moieties contain saturated carbon atoms (sp³) and no aromatic, sp² or sp carbon atoms. The number of carbon atoms in an alkyl moiety or group can vary and typically is 1 to about 50, e.g., about 1-30 or about 1-20, unless otherwise specified, e.g., C₁₋₈ alkyl or C₁-C₈alkyl means an alkyl moiety containing 1, 2, 3, 4, 5, 6, 7 or 8 carbon atoms and C₁₋₆ alkyl or C₁-C₆ means an alkyl moiety containing 1, 2, 3, 4, 5 or 6 carbon atoms. When an alkyl substituent, moiety or group is specified, species may include methyl, ethyl, 1-propyl (n-propyl), 2-propyl (iso-propyl, —CH(CH₃)₂), 1-butyl (n-butyl), 2-methyl-1-propyl (iso-butyl, CH₂CH(CH₃)₂), 2-butyl (sec-butyl, CH(CH₃)CH₂CH₃), 2-methyl-2-propyl (t-butyl, C(CH₃)₃), amyl, isoamyl, sec-amyl and other linear, cyclic and branch chain alkyl moieties. Unless otherwise specified, alkyl groups can contain species and groups described below for cycloalkyl, alkenyl, alkynyl groups, aryl groups, arylalkyl groups, alkylaryl groups and the like.

Cycloalkyl as used herein is a monocyclic, bicyclic or tricyclic ring system composed of only carbon atoms. The term “cycloalkyl” encompasses a monocyclic or polycyclic aliphatic, non-aromatic radical, wherein each of the atoms forming the ring (i.e. skeletal atoms) is a carbon atom. The number of carbon atoms in an cycloalkyl substituent, moiety or group can vary and typically is 3 to about 50, e.g., about 1-30 or about 1-20, unless otherwise specified, e.g., C₃₋₈ alkyl or C3-C8 alkyl means an cycloalkyl substituent, moiety or group containing 3, 4, 5, 6, 7 or 8 carbon atoms and C₃₋₆ alkyl or C3-C6 means an cycloalkyl substituent, moiety or group containing 3, 4, 5 or 6 carbon atoms. Cycloalkyl substituents, moieties or groups will typically have 3, 4, 5, 6, 7, 8, 9, 10, 11, 12, 13, 14, 15, 16, 17, 18, 19 or 20 carbon atoms and may contain exo or endo-cyclic double bonds or endo-cyclic triple bonds or a combination of both wherein the endo-cyclic double or triple bonds, or the combination of both, do not form a cyclic conjugated system of 4n+2 electrons; wherein the bicyclic ring system may share one (i.e., spiro ring system) or two carbon atoms and the tricyclic ring system may share a total of 2, 3 or 4 carbon atoms, typically 2 or 3. Unless otherwise specified, cycloalkyl substituents, moieties or groups can contain moieties and groups described for alkenyl, alkynyl, aryl, arylalkyl, alkylaryl and the like and can contain one or more other cycloalkyl moieties. Thus, cycloalkyls may be saturated, or partially unsaturated. Cycloalkyls may be fused with an aromatic ring, and the points of attachment to the aromatic ring are at a carbon or carbons of the cycloalkyl substituent, moiety or group that is not an aromatic ring carbon atom. Cycloalkyl groups include groups having from 3 to 10 ring atoms. Cycloalkyl substituents, moieties or groups include cyclopropyl, cyclopentyl, cyclohexyl, adamantly or other cyclic all carbon containing moieties. Cycloalkyls further include cyclobutyl, cyclopentenyl, cyclohexenyl, cycloheptyl and cyclooctyl. Cycloalkyl groups may be substituted or unsubstituted. Depending on the substituent structure, a cycloalkyl substituent can be a monoradical or a diradical (i.e., an cycloalkylene, such as, but not limited to, cyclopropan-1,1-diyl, cyclobutan-1,1-diyl, cyclopentan-1,1-diyl, cyclohexan-1,1-diyl, cyclohexan-1,4-diyl, cycloheptan-1,1-diyl, and the like). When cycloalkyl is used as a Markush group (i.e., a substituent) the cycloalkyl is attached to a Markush formula with which it is associated through a carbon involved in a cyclic carbon ring system carbon of the cycloalkyl group that is not an aromatic carbon.

“Alkylamine” as used herein means an N(alkyl)ₓH_{y} group, moiety or substituent where x and y are independently selected from the group x=1, y=1 and x=2, y=0. Alkylamine includes those —N(alkyl)ₓH_{y} groups wherein x=2 and y=0 and the alkyl groups taken together with the nitrogen atom to which they are attached form a cyclic ring system.

“Aryl” as used here means an aromatic ring system or a fused ring system with no ring heteroatoms comprising 1, 2, 3 or 4 to 6 rings, typically 1 to 3 rings, wherein the rings are composed of only carbon atoms; and refers to a cyclically conjugated system of 4n+2 electrons (Huckel rule), typically 6, 10 or 14 electrons some of which may additionally participate in exocyclic conjugation (cross-conjugated (e.g., quinone). Aryl substituents, moieties or groups are typically formed by five, six, seven, eight, nine, or more than nine, carbon atoms. Aryl substituents, moieties or groups are optionally substituted. Exemplary aryls include C₆-C₁₀ aryls such as phenyl and naphthalenyl and phenanthryl. Depending on the structure, an aryl group can be a monoradical or a diradical (i.e., an arylene group). Exemplary arylenes include, but are not limited to, phenyl-1,2-ene, phenyl-1,3-ene, and phenyl-1,4-ene. When aryl is used as a Markush group (i.e., a substituent) the aryl is attached to a Markush formula with which it is associated through aromatic carbon of the aryl group.

“Arylalkyl” as used herein means a substituent, moiety or group where an aryl moiety is bonded to an alkyl moiety, i.e., -alkyl-aryl, where alkyl and aryl groups are as described above, e.g., —CH₂—C₆H₅ or —CH₂CH(CH₃)—C₆H₅. When arylalkyl is used as a Markush group (i.e., a substituent) the alkyl moiety of the arylalkyl is attached to a Markush formula with which it is associated through a sp³ carbon of the alkyl moiety.

“Alkylaryl” as used herein means substituent, moiety or group where alkyl moiety is bonded to aryl moiety, i.e., -aryl-alkyl, where aryl and alkyl groups are as described above, e.g. —C₆H₄—CH₃ or —C₆H₄—CH₂CH(CH₃). When alkylaryl is used as Markush group (i.e., substituent), aryl moiety of alkylaryl is attached to Markush formula with which it is associated through sp² carbon of the aryl moiety. “Substituted alkyl”, “substituted cycloalkyl”, “substituted alkenyl”, “substituted alkynyl”, substituted alkylaryl”, “substituted arylalkyl”, “substituted heterocycle”, “substituted aryl” and the like as used herein mean alkyl, alkenyl, alkynyl, alkylaryl, arylalkyl heterocycle, aryl or other group or moiety as defined or disclosed herein that has substituent(s) that replaces hydrogen atom(s) or substituent(s) that interrupts carbon atom chain. Alkenyl and alkynyl groups that comprise substituent(s) are optionally substituted at carbon that is one or more methylene moieties removed from double bond.

“Heterocycle” or “heterocyclic” or “heteroaryl” as used herein means a cycloalkyl or aromatic ring system wherein one or more, typically 1, 2 or 3, but not all of the carbon atoms comprising the ring system are replaced by a heteroatom which is an atom other than carbon, including, N, O, S, Se, B, Si, P, typically N, O or S wherein two or more heteroatoms may be adjacent to each other or separated by one or more carbon atoms, typically 1-17 carbon atoms, 1-7 atoms or 1-3 atoms. Heterocycles includes heteroaromatic rings (also known as heteroaryls) and heterocycloalkyl rings (also known as heteroalicyclic groups) containing one to four heteroatoms in the ring(s), where each heteroatom in the ring(s) is selected from O, S and N, wherein each heterocyclic group has from 4 to 10 atoms in its ring system, and with the proviso that the any ring does not contain two adjacent O or S atoms.

Non-aromatic heterocyclic, substituents, moieties or groups (also known as heterocycloalkyls) have at least 3 atoms in their ring system and aromatic heterocyclic groups have at least 5 atoms in their ring system and include benzo-fused ring systems. Heterocyclics with 3, 4, 5, 6 and 10 atoms include aziridinyl azetidinyl, thiazolyl, pyridyl and quinolinyl, respectively. Nonaromatic heterocyclic substituents, moieties/groups are pyrrolidinyl, tetrahydrofuranyl, dihydrofuranyl, tetrahydrothienyl, oxazolidinonyl, tetrahydropyranyl, dihydropyranyl, tetrahydrothiopyranyl, piperidinyl, morpholinyl, thiomorpholinyl, thioxanyl, piperazinyl, aziridinyl, azetidinyl, oxetanyl, thietanyl, homopiperidinyl, oxepanyl, thiepanyl, oxazepinyl, diazepinyl, thiazepinyl, 1,2,3,6-tetrahydropyridinyl, pyrrolin-2-yl, pyrrolin-3-yl, indolinyl, 2H-pyranyl, 4H-pyranyl, dioxanyl, 1,3-dioxolanyl, pyrazolinyl, dithianyl, dithiolanyl, dihydropyranyl, dihydrothienyl, dihydrofuranyl, pyrazolidinyl, imidazolinyl, imidazolidinyl, 3-azabicyclo[3.1.0)hexanyl, 3azabicyclo[4.1.0)heptanyl, 3H-indolyl and quinolizinyl. Aromatic heterocyclic includes, by way of example and not limitation, pyridinyl, imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, quinolinyl, isoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, oxadiazolyl, thiadiazolyl, furazanyl, benzofurazanyl, benzo-thiophenyl, benzothiazolyl, benzoxazolyl, quinazolinyl, quinoxalinyl, naphthyridinyl and furopyridinyl. Non-aromatic heterocycles may be substituted with one or two oxo (═O) moieties and includes pyrrolidin-2-one.

When heterocycle is used as a Markush group (i.e., a substituent) the heterocycle is attached to a Markush formula with which it is associated through a carbon or a heteroatom of the heterocycle, where such an attachment does not result in an unstable or disallowed formal oxidation state of that carbon or heteroatom. A heterocycle that is C-linked is bonded to a molecule through a carbon atom include moieties such as —(CH₂)ₙ-heterocycle where n is 1, 2 or 3 or —C<heterocycle where C< represents a carbon atom in a heterocycle ring. A heterocycle that is N-linked is a nitrogen containing heterocycle that is bonded a heterocycle ring nitrogen sometimes described as —N<heterocycle where N< represents nitrogen atom in heterocycle ring. Thus, nitrogen-containing heterocycles may be C-linked or N-linked and include pyrrole substituents, which may be pyrrol-1-yl (N-linked) or pyrrol-3-yl (C-linked), imidazole substituents, which may be imidazol-1-yl or imidazol-3-yl (both N-linked) or imidazol-2-yl, imidazol-4-yl or imidazol-5-yl (all C-linked).

“Heteroaryl” as used herein means an aryl ring system wherein one or more, typically 1, 2 or 3, but not all of the carbon atoms comprising the aryl ring system are replaced by a heteroatom which is an atom other than carbon, including, N, O, S, Se, B, Si, P, typically, oxygen (—O—), nitrogen (—NX—) or sulfur (—S—) where X is —H, protecting group or C₁₋₆ optionally substituted alkyl, wherein heteroatom participates in conjugated system either through pi-bonding with adjacent atom in ring system or through lone pair of electrons on heteroatom and may be optionally substituted on one or more carbons or heteroatoms, or combination of both, in manner which retains cyclically conjugated system. Examples of heteroaryls include by way of example and not limitation pyridyl, thiazolyl, pyrimidinyl, furanyl, thienyl, pyrrolyl, pyrazolyl, purinyl, imidazolyl, benzofuranyl, indolyl, isoindoyl, quinolinyl, isoquinolinyl, benzimidazolyl, pyridazinyl, pyrazinyl, benzothiopyran, benzotriazine, isoxazolyl, pyrazolopyrimidinyl, quinoxalinyl, thiadiazolyl, triazolyl and the like. Heterocycles that are not heteroaryls include, by way of example and not limitation, tetrahydrothiophenyl, tetrahydrofuranyl, indolenyl, piperidinyl, pyrrolidinyl, 2-pyrrolidonyl, tetrahydroquinolinyl, tetrahydroisoquinolinyl, decahydroquinolinyl, octahydroisoquinolinyl, 2H-pyrrolyl, 3H-indolyl, 4H-quinolizinyl, imidazolidinyl, imidazolinyl, pyrazolidinyl, piperazinyl, quinuclidinyl, morpholinyl, oxazolidinyl and the like.

Monocyclic heteroaryls include, by way of example and not limitation, pyridinyl, imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, pyridazinyl, triazinyl, oxadiazolyl, thiadiazolyl, and furazanyl. Heteroaryls include those substituents, moieties or groups containing 0-3 N atoms, 1-3 N atoms or 0-3 N atoms, 0-1 O atoms and 0-1 S atoms. A heteroaryl may be monocyclic or bicyclic. The ring system of a heteroaryls ring typically contains 1-9 carbons (i.e., C₁-C₉ heteroaryl). Monocyclic heteroaryls include C₁-C₅ heteroaryls. Monocyclic heteroaryls include those having 5-membered or 6-membered ring systems. Bicyclic heteroaryls include C₆-C₉ heteroaryls. Depending on the structure, a heteroaryl group can be a monoradical or a diradical (i.e., a heteroarylene group).

“Halogen” or “halo” as used herein means fluorine, chlorine, bromine or iodine. “Haloalkyl” as used herein means an alkyl substituent moiety or group in which one or more of its hydrogen atoms are replaced by one or more independently selected halide atoms. Haloalkyl includes C₁-C₄ haloalkyl. Example but non-limiting C₁-C₄ haloalkyls are —CH₂Cl, —CH₂Br, CH₂I, —CHBrCl, —CHCl—CH₂Cl and —CHCl—CH₂I. “Haloalkylene” as used herein means an alkylene substituent, moiety or group in which one or more hydrogen atoms are replaced by one or more halide atoms. Haloalkylene includes C₁-C₆ haloalkylenes or C₁-C₄haloalkylenes. “Fluoroalkyl” as used herein means an alkyl in which one or more hydrogen atoms are replaced by a fluorine atom. Fluoroalkyl includes C₁-C₆ and C₁-C₄ fluoroalkyls. Example but non-limiting fluoroalkyls include —CH₃F, —CH₂F₂ and —CF₃ and perfluroalkyls. “Fluoroalkylene” as used herein means an alkylene in which one or more hydrogen atoms are replaced by a fluorine atom. Fluoroalkylene includes C₁-C₆ fluoroalkylenes or C₁-C₄ fluoroalkylenes.

The term “heteroalkyl” refers to an alkyl group in which one or more skeletal atoms of the alkyl are selected from an atom other than carbon, e.g., oxygen, nitrogen, sulfur, phosphorus or combinations thereof. In one aspect, a heteroalkyl is a C₁-C₆ heteroalkyl.

As used herein, the term “alkylene”, employed alone or in combination with other terms, refers to a divalent alkyl linking group. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like.

As used herein, the term “alkoxy”, employed alone or in combination with other terms, refers to a group of formula O-alkyl, wherein the alkyl group as defined above. Example alkoxy groups include but not limited to methoxy, ethoxy, propoxy (e.g., n-propoxy and isopropoxy), t-butoxy, and the like.

As used herein, the term “alkylalkoxy”, employed alone or in combination with other terms, refers to a group of formula alkyl-O-alkyl, wherein the alkyl group is as defined above.

As used herein, the term “alkylamino” refers to a group of formula —NH(alkyl), wherein the alkyl group is as defined above.

As used herein, the term “alkoxycarbonyl” refers to a group of formula —C(O)O-alkyl, wherein the alkyl group is as defined above.

As used herein, the term “alkylcarbonylamino” refers to a group of formula —NHC(O)-alkyl, wherein the alkyl group is as defined above.

As used herein, the term “alkylsulfonylamino” refers to a group of formula —NHS(O)₂-alkyl, wherein the alkyl group is as defined above.

As used herein, the term “aminosulfonyl” refers to a group of formula —S(O)₂NH₂.

As used herein, the term “alkylaminosulfonyl” refers to a group of formula —S(O)₂NH(alkyl), wherein the alkyl group is as defined above.

As used herein, the term “aminocarbonyl”, employed alone or in combination with other terms, refers to a group of formula —NHC(O)—.

As used herein, the term “alkylaminocarbonyl”, employed alone or in combination with other terms, refers to a group of formula alkyl-NHC(O)— or —NHC(O)-alkyl-.

As used herein, the term “alkylacylamino”, employed alone or in combination with other terms, refers to a group of formula alkyl-C(O)-alkyl/aryl/heteroparyl-NH₂.

As used herein, the term “aminocarbonylamino”, employed alone or in combination with other terms, refers to a group of formula —NHC(O)NH₂.

As used herein, the term “sulfanyl” or “thio” refers to a group of formula —SH.

As used herein, the term “alkylthio” or “alkylsulfanyl” refers to a group of formula —S-alkyl, wherein the alkyl group is as defined above.

As used herein, the term “arylthio” or “arylsulfanyl” refers to a group of formula —S-aryl, wherein the aryl group is as defined above.

As used herein, the term “heteroarylthio” or “heteroarylsulfanyl” refers to a group of formula S-heteroaryl, wherein the heteroaryl group is as defined above.

As used herein, the term “sulfonyl” refers to a group of formula —S(O)₂—.

As used herein, the term “alkylsulfonyl” refers to a group of formula —S(O)₂-alkyl, wherein the alkyl group is as defined above.

As used herein, the term “arylsulfonyl” refers to a group of formula —S(O)₂-aryl, wherein the aryl group is as defined above.

As used herein, the term “heteroarylsulfonyl” refers to a group of formula —S(O)₂-heteroaryl, wherein the heteroaryl group is as defined above.

As used herein, the term “sulfonyloxy” refers to a group of formula —S(O)₂—O—.

As used herein, the term “alkylsulfonyloxy” refers to a group of formula —S(O)₂—O-alkyl, wherein the alkyl group is as defined above.

As used herein, the term “sulfinyl” refers to a group of formula —S(O)—.

As used herein, the term “alkylsulfinyl” refers to a group of formula —S(O)-alkyl, wherein the alkyl group is as defined above.

As used herein, the term “arylsulfinyl” refers to a group of formula —S(O)-aryl, wherein the aryl group is as defined above.

As used herein, the term “amino” refers to a group of formula —NH₂.

As used herein, the term “carbamyl” to a group of formula —C(O)NH₂.

As used herein, the term “carbonyl”, employed alone or in combination with other terms, refers to a C(O) group.

As used herein, the term “alkylcarboxy” refers to a group of formula —C(O)OH connected with at least one of alkyl group.

As used herein, the term “dialkylamino” refers to a group of formula —N(alkyl)₂, wherein the two alkyl groups each is as defined above.

As used herein, “haloalkoxy” refers to a group of formula —O-haloalkyl where alkyl and halo/halogen is as defined above. An example haloalkoxy group is OCF₃. In some embodiments, the haloalkoxy group is fluorinated only.

As used herein, the term “haloalkyl”, employed alone or in combination with other terms, refers to an alkyl group having from one halogen atom to 2 s+1 halogen atoms which may be the same or different, where “s” is the number of carbon atoms in the alkyl group, wherein the alkyl and halo is as defined above.

As used herein, “haloaryl” refers to a group of formula halo-aryl where aryl and halo/halogen is as defined above.

The compounds described herein can be asymmetric (e.g., having one or more stereocenters). All stereoisomers, such as enantiomers and diastereomers, are intended unless otherwise indicated. Compounds of the present invention that contain asymmetrically substituted carbon atoms can be isolated in optically active or racemic forms. Methods on how to prepare optically active forms from optically inactive starting materials are known in the art, such as by resolution of racemic mixtures or by stereoselective synthesis. Many geometric isomers of olefins, C═N double bonds, and the like can also be present in the compounds described herein, and all such stable isomers are contemplated in the present invention. Cis and trans geometric isomers of the compounds of the present invention are described and may be isolated as a mixture of isomers or as separated isomeric forms. In some embodiments, the compound has the (R)-configuration. In some embodiment, compound has (S)-configuration.

Compounds of the invention also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone-enol pairs, amide-imidic acid pairs, lactam-lactim pairs, enamine-imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

Compounds of invention can also include all isotopes of atoms occurring in intermediates or final compounds. Isotopes include those atoms having the same atomic number but different mass numbers. For example, isotopes of hydrogen include tritium and deuterium. The term, “compound,” used herein is meant to include all stereoisomers, geometric isomers, tautomers, and isotopes of structures depicted. Compounds herein identified by name or structure as one particular tautomeric form are intended to include other tautomeric forms unless otherwise specified. All compounds, and pharmaceutically acceptable salts thereof, can be found together with other substances such as water and solvents (e.g. hydrates and solvates) or can be isolated.

In some embodiments, the compounds of the invention, or salts thereof, are substantially isolated. By “substantially isolated” is meant that the compound is at least partially or substantially separated from the environment in which it was formed or detected. Partial separation can include, for example, a composition enriched in the compounds of the invention. Substantial separation can include compositions containing at least about 50%, at least about 60%, at least about 70%, at least about 80%, at least about 90%, at least about 95%, at least about 97%, or at least about 99% by weight of the compounds of the invention, or salt thereof. Methods for isolating compounds and their salts are routine in the art.

The expressions, “ambient temperature” and “room temperature” or “rt” as used herein, are understood in the art, and refer generally to a temperature, e.g. a reaction temperature, that is about the temperature of the room in which the reaction is carried out, for example, a temperature from about 20° C. to about 30° C.

The present invention provides a nickel based catalyst of formula (I):

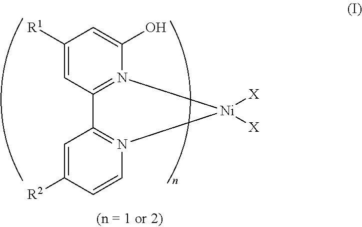

wherein,
R¹ is selected from hydrogen, C1-C4 alkyl, and aryl;
R² is selected from hydrogen, C1-C4 alkyl, and aryl; and
X is selected from halogen, —OCO-alkyl, OAc, —OTf.

In specific aspect, in the nickel catalyst of formula (I) covers the aryl of R1 and/or R2 as phenyl which may be further substituted with any of group selected from C1-C4alkyl, aryl, alkoxy, halo, —OTf, —OCO-alkyl and —OAc; the alkyl connected to —OCO— is C1-C4 alkyl; and the halogen is selected from chloro, iodo, bromo and fluoro.

The present invention provides a process of preparation of said nickel based catalyst of formula I comprising steps of:
a) adding 0.91-9.1 mmol of dimethoxy ethane nickel compound of formula II with 0.91-9.1 mmol of hydroxy bipyridine in presence of solvent under inert argon atmosphere in a round bottom glass flask to obtain a mixture

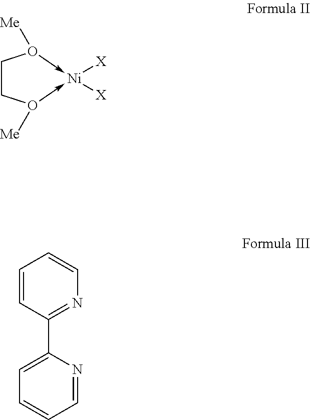

wherein X is same as defined under formula I;
b) stirring the mixture as obtained in step a) at a temperature in the range of 25 to 60° C. for a time period of 12-24 hrs;
c) evaporating and drying the reaction mixture obtained in step b) to obtain the catalyst of formula I; and
d) optionally, purifying the catalyst to obtain the catalyst of formula I.

The solvent used in step a) is selected from methanol, ethanol, toluene, and THF. The evaporation and drying in step c) is done by first evaporating solvent in vacuo to obtain solid product, followed by washing with diethyl ether and subsequent drying under vacuum provided the catalyst of formula I.

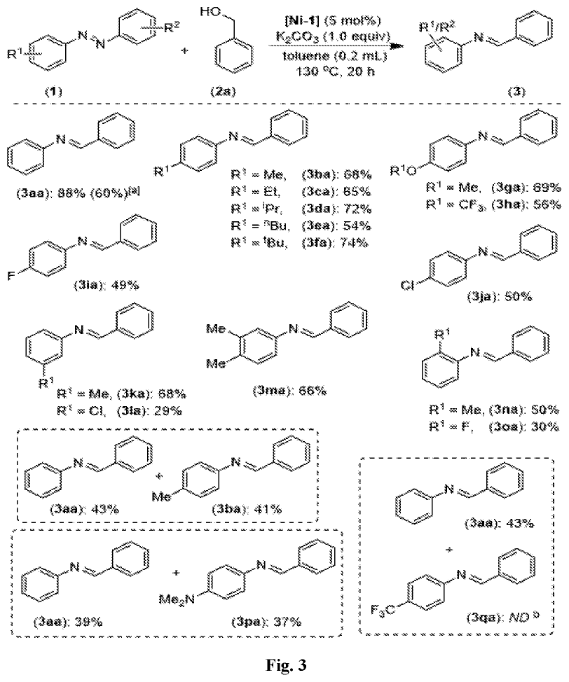

The synthetic scheme of compound of formula I is shown in FIG. 2.

The yield of compound of formula I obtained by said process is in range of 75-85% with 90% selectivity and 95% conversion rate.

The present invention provides a process of hydrogenation-dehydrogenation coupling reaction catalysed by the catalyst of formula (I), the process comprising steps of:
a) reacting 0.02 to 1 mmol of azobenzene of formula IV (E-1,2-diaryldiazene) with 0.04 to 2 mmol of a (un)substituted benzyl alcohol of formula V in presence of 0.001 to 0.05 mmol of the catalyst of formula (I), 0.02 to 1 mmol of a base, and a solvent in a schlenk tube to obtain a reaction mixture;

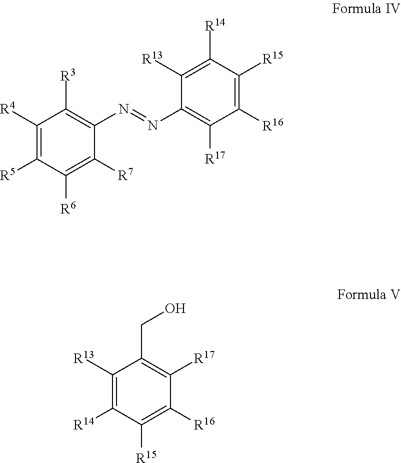

wherein
   R3: hydrogen, alkyl, halogen, cycloalkyl;
   R4: hydrogen, alkyl, alkoxy, halogen, cycloalkyl;
   R5: hydrogen, alkyl, alkoxy, sulphonyl alkyl, —OCF3, —OCHF2, —COO-alkyl, halogen;
   R6: hydrogen, alkyl, alkoxy, halogen, cycloalkyl;
   R7: hydrogen, alkyl, halogen, cycloalkyl;
   R8: hydrogen, alkyl, halogen, cycloalkyl;
   R9: hydrogen, alkyl, alkoxy, halogen, cycloalkyl;
   R10: hydrogen, alkyl, alkoxy, sulphonyl alkyl, aminoalkyl, amino, —OCF3, —OCHF2, —COO-alkyl, halogen;
   R11: hydrogen, alkyl, alkoxy, halogen, cycloalkyl;
   R12: hydrogen, alkyl, halogen, cycloalkyl;
   R13: hydrogen, alkyl, alkoxy, —CF3, cycloalkyl;
   R14: hydrogen, alkyl, alkoxy, —CF3, halogen, cycloalkyl;
   R15: hydrogen, alkyl, alkoxy, sulphonyl alkyl, —O-aryl, —OCF3, —CF3, halogen;
   R16: hydrogen, alkyl, alkoxy, —CF3, halogen; and
   R17: hydrogen, alkyl, alkoxy, —CF3, cycloalkyl;
b) heating the reaction mixture obtained in step a) at a temperature in the range of 120-150° C. for a time period in the range of 16-24 h to obtain a hot reaction mixture; and
c) cooling the hot reaction mixture obtained in step b) to an ambient temperature in the range of 25-35° C. followed by filtration to obtain the (un)substituted of (E)-N,1-diphenylmethanimine compounds of Formula IIa and/or IIb

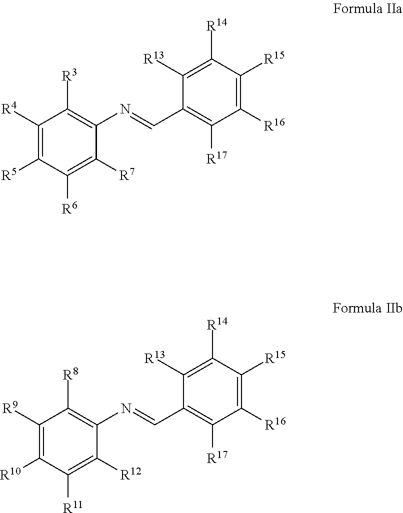

wherein R³, R⁴, R⁵, R⁶, R⁷, R⁸, R⁹, R¹⁰, R¹¹, R¹², R¹³, R¹⁴, R¹⁵, R¹⁶ and R¹⁷ is same as defined above, optionally R¹⁵ and R¹⁶ together forms a cyclic ring selected from aryl or heteroaryl ring.

In formula IIa or IIb, the R¹⁵ and R¹⁶ together forms a cyclic ring selected from aryl or heteroaryl ring.

In the formula IIa or IIb, IV and V, the alkyl is selected from C1-C6 alkyl, halogen is selected from chloro, bromo, fluoro and iodo, alkyl in alkoxy, sulphonyl alkyl, aminoalkyl and —COO-alkyl groups are selected from C1-C4 alkyl, aryl in O-aryl is selected from substituted or unsubstituted aryl which may be phenyl, benzyl.

The base is selected from potassium carbonate (iK₂CO₃), potassium tertiary butoxide (KtOBu), and Tripotassium phosphate (K₃PO₄).

The solvent is selected from toluene, o-xylene, m-xylene, and p-xylene.

The present invention provides process of secondary imine hydrogenation reaction catalyzed by the catalyst of formula (I), the process comprising steps of:
a) reacting 0.02 to 1 mmol of azobenzene of formula IV (E-1,2-diaryldiazene) with 0.07 to 3.5 mmol of (un)substituted benzyl alcohol of formula V in presence of 0.001 to 0.05 mmol of catalyst of formula (I), 0.03 to 1.5 mmol of a base, and a solvent in a Schlenk tube to obtain a reaction mixture;

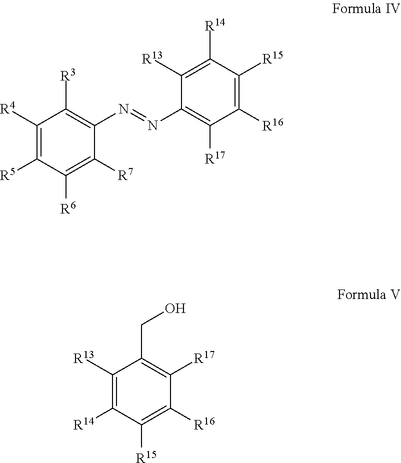

wherein
R3: hydrogen, alkyl, halogen, cycloalkyl;
R4: hydrogen, alkyl, alkoxy, halogen, cycloalkyl;
R5: hydrogen, alkyl, alkoxy, sulphonyl alkyl, —OCF3, —OCHF2, —COO-alkyl, halogen;
R6: hydrogen, alkyl, alkoxy, halogen, cycloalkyl;
R7: hydrogen, alkyl, halogen, cycloalkyl;
R8: hydrogen, alkyl, halogen, cycloalkyl;
R9: hydrogen, alkyl, alkoxy, halogen, cycloalkyl;
R10: hydrogen, alkyl, alkoxy, sulphonyl alkyl, aminoalkyl, amino, —OCF3, —OCHF2, —COO-alkyl, halogen;
R11: hydrogen, alkyl, alkoxy, halogen, cycloalkyl;
R12: hydrogen, alkyl, halogen, cycloalkyl;
R13: hydrogen, alkyl, alkoxy, —CF3, cycloalkyl;
R14: hydrogen, alkyl, alkoxy, —CF3, halogen, cycloalkyl;
R15: hydrogen, alkyl, alkoxy, sulphonyl alkyl, —O-aryl, —OCF3, —CF3, halogen;
R16: hydrogen, alkyl, alkoxy, —CF3, halogen; and
R17: hydrogen, alkyl, alkoxy, —CF3, cycloalkyl;
b) heating the reaction mixture to a temperature in the range of 120-150° C. for a time period of 16-24 h to obtain a hot reaction mixture; and
c) cooling the hot reaction mixture to room temperature of 25-35° C. followed by filtration to obtain the (un)substituted N-benzylaniline of formula IIIa and/or IIIb

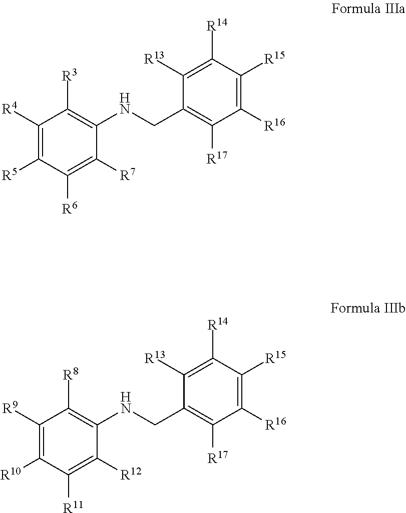

wherein R3, R4, R5, R6, R7, R8, R9, R10, R11, R12, R13, R14, R15, R16 and R17 is same as defined above, optionally R15 and R16 together forms a cyclic ring selected from aryl or heteroaryl ring.

In formula IIIa or IIIb, the R¹⁵ and R¹⁶ together forms a cyclic ring selected from aryl or heteroaryl ring.

In the formula IIa or IIb, IV and V, the alkyl is selected from C1-C6 alkyl, halogen is selected from chloro, bromo, fluoro and iodo, alkyl in alkoxy, sulphonyl alkyl, aminoalkyl and —COO-alkyl groups are selected from C1-C4 alkyl, aryl in O-aryl is selected from substituted or unsubstituted aryl which may be phenyl, benzyl.

The base is selected from potassium bis(trimethylsilyl)amide (KHMDS), and potassium tertiary butoxide (KtOBu).

The solvent is selected from toulene, o-xylene, m-xylene, and p-xylene.

In the compound of formulas IIa, IIb, IIIa, IIIb, IV and V, the alkyl is selected from C1-C6 alkyl; halogen is selected from chloro, bromo, fluoro and iodo; the alkyl in alkoxy, sulphonyl alkyl, aminoalkyl and —COO-alkyl groups are selected from C1-C4 alkyl; and the aryl in O-aryl is selected from substituted or unsubstituted aryl. The general scheme of above processes is provided below:

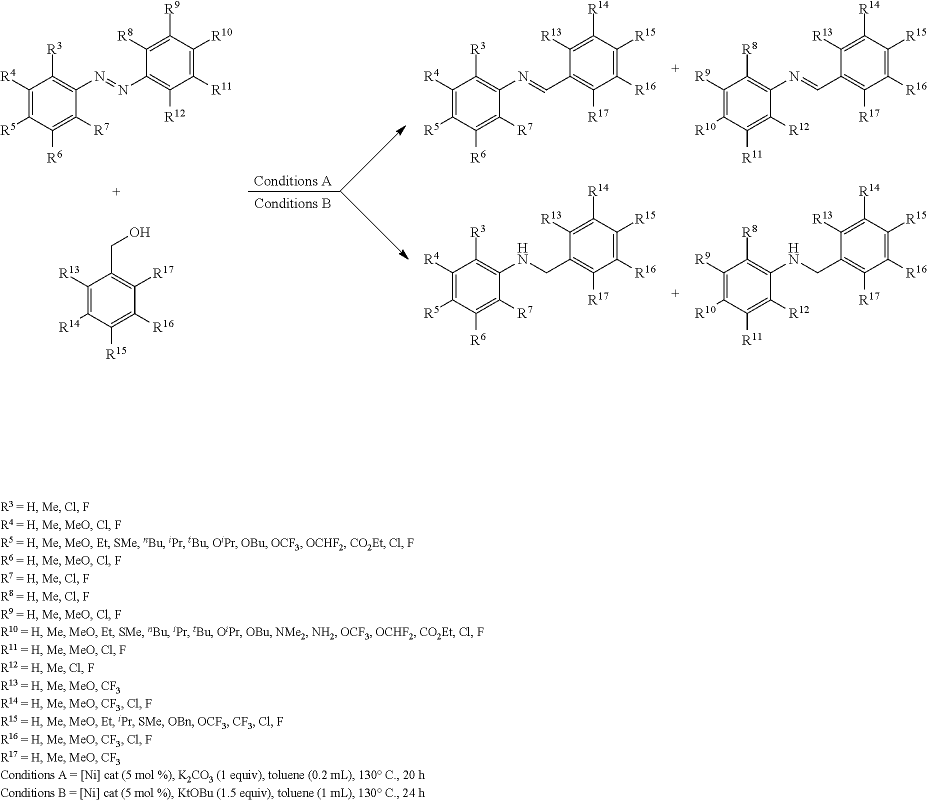

The present invention provides selective hydrogenative coupling of azobenzene with benzyl alcohols to produce imines, amines and diphenyl acrylonitrile. The developed catalyst is novel and indigenous.

The present invention provides an earth-abundant nickel catalytic system of formula I for the (de)hydrogenative coupling of azoarenes with benzyl alcohols via borrowing-hydrogen (hydrogen-auto transfer) strategy. This coupling leads to the selective formation of C—N bonds containing key products, secondary imines and amines, and produces water as a sole byproduct. The nickel catalyst along with the K2CO3 or KOtBu base governed the selectivity in imines and amines formation. The notable features of this protocol are (i) N═N bond activation, (ii) azo compound as a nitrogen source, (iii) chemodivergent synthesis of imines and amines, (iv) highly abundant and inexpensive nickel as a catalyst, (v) H2O as a sole byproduct, and (vi) no H2 evolution.

### EXAMPLES

Following examples are given by way of illustration and therefore should not be construed to limit the scope of the invention.

### Example 1

### A: Synthesis and Characterization of Catalyst Ni-1

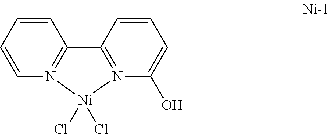

To a round bottom flask, (DME)NiCl₂ (0.2 g, 0.91 mmol) and 6-hydroxy-2,2′-bipyridine (0.157 g, 0.91 mmol) was charged and methanol (10 mL) was added under inert atmosphere. The reaction mixture was stirred at room temperature for 12 h, during which a green coloured clear solution was formed. Methanol was evaporated on vacuo and the resulted green solid was washed with Et₂O (10 mL×2) and dried under vacuum to obtain (6-hydroxy-2,2′-bipyridine)NiCl₂, Yield: 0.231 g, 84%. Anal. Calcd for C₁₀H₈Cl₂N₂ONi: C, 39.8; H, 2.67; N, 9.13. Found: C, 37.36; H, 2.73; N, 8.26.

### B: Synthesis and Characterization of Catalyst

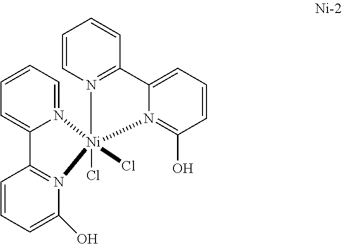

The synthesis procedure is same as followed in example 1A, for Ni-1 catalyst with some changes like amount of (DME)NiCl₂ is 0.1 g, 0.455 mmol, and solvent is dichloromethane which gives (6-hydroxy-2,2′-bipyridine)₂-NiCl₂. Yield: 0.170 g (79%). Anal. Calcd for C₁₀H₈Cl₂N₂ONi: C, 39.8; H, 2.67; N, 9.13. Found: C, 37.36; H, 2.73; N, 8.26.

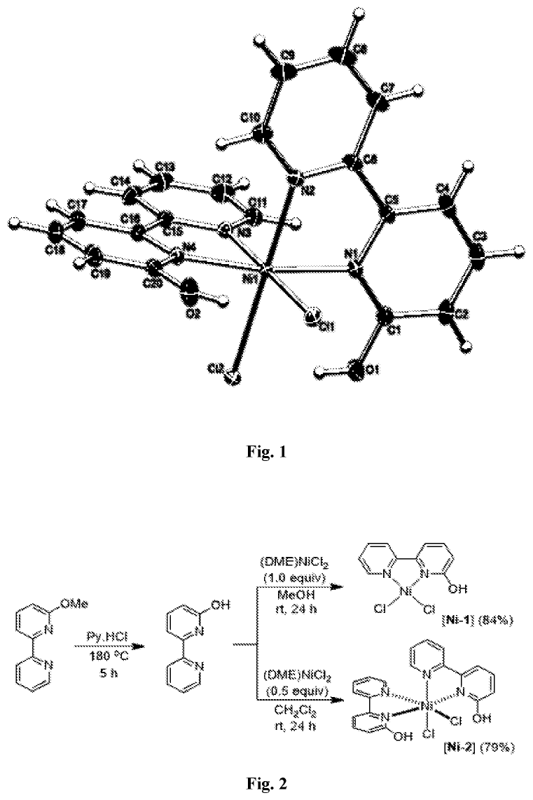

The single-crystal X-ray diffraction study established the molecular structure of complex Ni-2 (FIG. 1). In the structure of Ni-2, the two bidentate NN-ligand bind to the nickel making a distorted octahedral geometry around the nickel. The pyridine nitrogen (N_{py}), N₃, and N₂ lie trans to Cl1 and Cl2, making the bond angle N3-Ni1-Cl1 and N2-Ni1-Cl2 almost linear, 178.81(6)° and 177.78(6°, respectively.

### Example 2

### A: Procedure for the Synthesis of (E)-N,1-Diphenylmethanimine

An oven dried 25 mL Schlenk tube was charged with cat Ni-1 (0.003 g, 0.01 mmol, 5 mol %), K₂CO₃ (0.028 g, 0.2 mmol), azobenzene 1a (0.036 g, 0.2 mmol), benzyl alcohol 2a (0.043 g, 0.4 mmol) and toluene (0.2 mL) inside the glove box. The resultant reaction mixture in the tube was immersed in preheated oil bath at 130° C. and stirred for 20 h. After the completion of reaction, the reaction was cooled to ambient temperature and filtered through filter paper, and volatile was evaporated under vacuum. The crude product was dissolved in CDCl3 (0.8 mL) and CH2Br2 (0.014 mL, 0.20 mmol) was added to it. The 1H NMR yield of product 3aa was calculated to be 88%. Purification by column chromatography on neutral alumina (petroleum ether) yielded 3aa (0.044 g, 60%) as a light-yellow liquid (FIG. 3). 1H-NMR (400 MHz, CDCl₃): δ=8.5 (s, 1H, CH), 7.97-7.95 (m, 2H, Ar—H), 7.53-7.52 (m, 3H, Ar—H), 7.47-7.43 (m, 2H, Ar—H), 7.30-7.26 (m, 3H, Ar—H). HRMS (ESI): m/z Calcd for C₁₃H₁₁N+H⁺M+H⁺ 182.0964; Found 182.0965.

### B: Procedure for the Synthesis of N-Benzylaniline

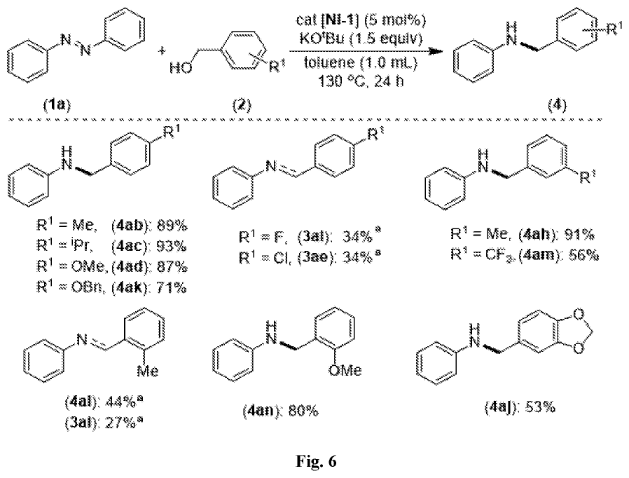

An oven dried 25 mL Schlenk tube was charged with cat Ni-1 (0.003 g, 0.01 mmol, 5.0 mol %), KO^{t}Bu (0.034 g, 0.3 mmol), azobenzene 1a (0.036 g, 0.2 mmol), benzyl alcohol 2a (0.076 g, 0.7 mmol) and toluene (1 mL) inside the glove box. The resultant reaction mixture in the tube was immersed in preheated oil bath at 130° C. and stirred for 20 h. After the completion of reaction, the reaction was cooled to room temperature and filtered through filter paper, and concentrated under vacuum. After the removal of volatiles, the residue was purified through column chromatography on silica gel (petroleum ether/EtOAc; 20/1) to yield N-benzylaniline (4aa) (0.070 g, 96%) as a brown oil (FIG. 5). ¹H-NMR (400 MHz, CDCl₃): δ=7.38-7.31 (m, 4H, Ar—H), 7.28-7.22 (m, 1H, Ar—H), 7.18-7.15 (m, 2H, Ar—H), 6.71 (t, J=7.38 Hz, 1H, Ar—H), 6.63 (d, J=8.13 Hz, 2H, Ar—H), 4.32 (s, 2H, CH₂), 4.00 (br s, 1H, NH). ¹³C{H}-NMR (100 MHz, CDCl₃): δ=148.3 (Cq), 139.6 (Cq), 129.43 (2C, CH), 128.80 (2C, CH), 127.68 (2C, CH), 127.40 (CH), 117.74 (CH), 113.02 (2C, CH), 48.50 (CH₂). IRMS (ESI): m/z Calcd for C₁₃H₁₃N+H⁺M+H⁺ 184.1121; Found 184.1120.

The inventors provide the (de)hydrogenative coupling reactions of the azo compound (1a) with benzyl alcohol (2a) by the N═N bond activation via borrowing-hydrogen strategy using newly developed nickel catalysts Ni-1 and Ni-2 (Table 1):

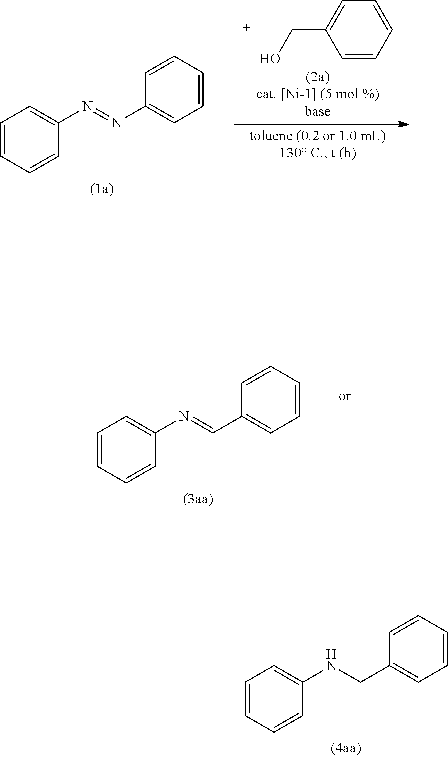 [SMILES: c1ccc(/N=N/c2ccccc2)cc1 ; OCc1ccccc1 ; C(=N\c1ccccc1)/c1ccccc1 ; c1ccc(CNc2ccccc2)cc1]

TABLE 1

| | equiv | | | | |
|---|---|---|---|---|---|
| Entry | of 2a | base (equiv) | t (h) | 3aa ^{b} | 4aa ^{b} |
| 1 ^{c} | 2.0 | KO^{t}Bu (0.4) | 12 | 17 | — |
| 2 | 2.0 | KO^{t}Bu (0.4) | 12 | 78 | — |
| 3 | 2.0 | KO^{t}Bu (0.5) | 12 | 65 | 15 |
| 4 | 2.0 | LiO^{t}Bu (0.4) | 12 | 8 | — |
| 5 | 2.0 | NaO^{t}Bu (0.4) | 12 | 10 | — |
| 6 | 2.0 | K₂CO₃ (0.5) | 12 | 68 | — |
| 7 | 2.0 | K₂CO₃ (1.0) | 20 | 88 | — |
| 8 | 2.0 | K₃PO₄ (1.0) | 20 | 84 | — |
| 9 | 2.0 | KOAc (1.0) | 20 | 8 | — |
| 10 ^{d} | 2.0 | K₂CO₃ (1.0) | 20 | 31 | — |
| 11 | 3.5 | K₂CO₃ (1.5) | 24 | 78 | — |
| 12 | 3.5 | KO^{t}Bu (1.0) | 24 | 12 | 76 |
| 13 | 3.5 | KO^{t}Bu (1.5) | 24 | — | 99 (95) |
| 14 ^{d} | 3.5 | KO^{t}Bu (1.5) | 24 | 11 | 80 |

^{a}Reaction conditions: 1a (0.037 g, 0.203 mmol), Ni-1 (0.003 g, 0.01 mmol, 5 mol %).
^{b} Yield by ¹H NMR analysis, isolated yield is in parenthesis.
^{c} Without solvent.
^{d} Using catalyst Ni-2. Entries 2-11: 0.2 mL toluene was used, Entries 12-14: 1.0 mL toluene was used.

With the optimized conditions (as per table 1) for the chemo divergent transformations of azo compounds in place, first, inventors have provided the synthesis of imines from substituted azoarenes and benzyl alcohol (refer, FIG. 3). A series of para-alkyl substituted azoarenes participated in the (de)hydrogenative coupling with benzyl alcohol employing Ni-1/K2CO3/toluene (0.2 mL) system that delivered imines (3ba-3fa) selectively in good yields. Alkoxy, trifluoro alkoxy, fluoro, and chloro functionalities were tolerated at the para-position of azobenzene, providing the imines 3ga-3ja. The compatibility of halide functionalities is crucial because of their synthetic perspective. Azoarenes bearing meta-substitution also delivered the imines in good yields (3ka-3ma), whereas the ortho-substituted azoarenes provided imines 3na and 3oa in low yields. The unsymmetrical azoarenes containing phenyl and para-tolyl units provided the two possible imines, 3aa and 3ba, in excellent yields. Similarly, the N,N-dimethyl-4-(phenyldiazenyl)aniline gave imines 3aa and 3pa in good yields. However, the 1-phenyl-2-(4-(trifluoromethyl)phenyl)diazene afforded only imine 3aa, and the other possible imine 3qa was not observed. This observation indicates the low reactivity of electron-deficient aniline intermediate towards the imination.

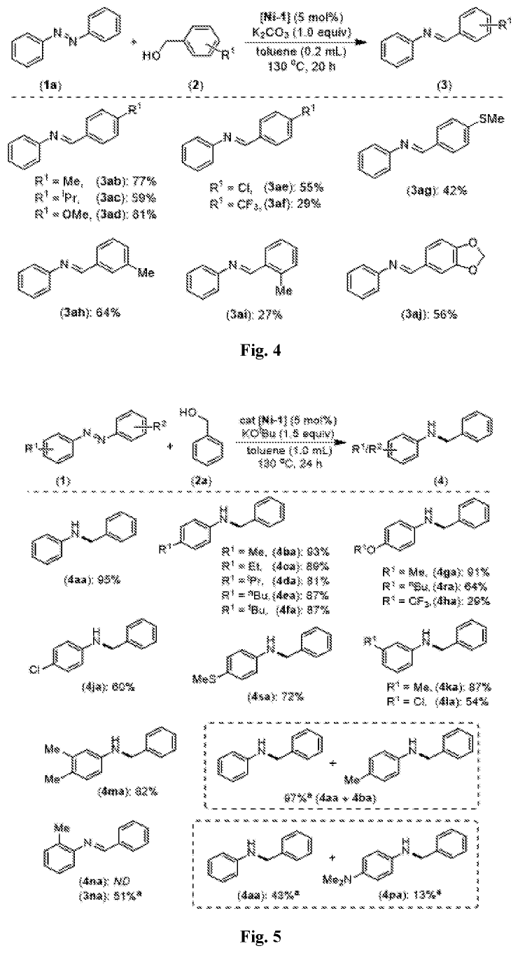

The azo reductive-imination condition was employed for azobenzene's (de)hydrogenative coupling with various benzyl alcohols (refer, FIG. 4). Thus, a series of benzyl alcohols engaged in the reaction with azobenzene leading to diverse imines. The electron-rich benzyl alcohols performed well, whereas the electron-poor and sterically demanding are low reactive. Moderate yields were observed in the case of benzyl alcohol-containing thioether and ether linkages, 3ag (42%) and 3aj (56%).

The use of the Ni-1/KOtBu/toluene (1.0 mL) system led to the (de)hydrogenative coupling of diversely substituted azoarenes with benzyl alcohol affording secondary amines in good to excellent yields (refer, FIG. 5). A range of alkyl groups and alkoxy, trifluoromethoxy, and chloride moieties were permissible at the para-position of azoarene, affording the selective amines 4ba-4ja and 4ra. A thiomethyl-containing azo compound provided the amine 4sa in 72% yield. The compatibility of the thioether is crucial as such functionality is known as catalyst quencher. In addition to the para-substituted azoarene, the meta-substituted azoarenes participated in the (de)hydrogenative amination to afford 4ka-4ma in good to excellent yields. Notably, the ortho-methyl substituted azobenzene provided imine 3na, wherein further hydrogenation to amine 4na was not observed. The unsymmetrical azoarene provided two different amines, 4aa and 4ba, in excellent yields. Similarly, the methyl-yellow azodye, N,N-dimethyl-4-styrylaniline (lap) gave unsubstituted amine 4aa in 43% yield and the para-NMe2 substituted amine 4pa in 13% yield.

The benzyl alcohols with methyl, isopropyl, methoxy, and benzyloxy at the para-position reacted efficiently to deliver aminated compounds 4ab, 4ac, 4ad, and 4ak in excellent yields (refer, FIG. 6). Notably, the para-fluoro and para-chloro benzyl alcohols reacted to produce the corresponding imines 3al and 3ae in 34% each, respectively, instead of desired aminated compounds. The meta-substituted benzyl alcohols could provide preferred aminated products 4ah and 4am in 91% and 56% yields, respectively. Gratifyingly, the coupling of ortho-methoxybenzyl alcohol with azobenzene furnished amine 4an in 80%. A fused ring cyclic ether, benzo-1,3-dioxol-5-ylmethanol, participated in this (de)hydrogenative amination to afford selectively aminated compound 4aj in 53% yield. Nevertheless, the employment of Ni-1 catalyst with K2CO3/toluene (0.2 mL) exclusively provided secondary imines, whereas the same catalyst with KOtBu/toluene (1.0 mL) afforded secondary amines. This chemodivergent synthetic protocol of imines and amines from azoarenes is notable and can be explored for other (de)hydrogenative couplings, such as chemodivergent coupling of benzyl alcohols with benzyl nitriles or secondary alcohols.

### Comparative Example 1: Procedure for TEMPO/BHT Added Experiment (in the Compound 3aa Synthesis)

An oven dried 25 mL Schlenk tube was charged with 1a (0.037 g, 0.203 mmol), K2CO3 (0.028 g, 0.2 mmol), TEMPO (0.063 g, 0.403 mmol) [or BHT (0.089, 0.404 mmol)], Ni-1 (0.003 g, 0.01 mmol, 5 mol %), 2a (0.044 g, 0.406 mmol), and toluene (0.2 mL) inside the glove box. The tube was sealed by a glass stopper and the resultant reaction mixture in the tube was immersed in preheated oil bath at 130° C. and stirred for 20 h. At ambient temperature, the reaction mixture was diluted with EtOAc and filtered through filter paper. Then, the volatiles were removed under vacuo and dried. The 1H NMR analysis indicated no formation of product in case of TEMPO and shows 20% of 3aa in case of BHT.

### Comparative Example 2: Procedure for TEMPO/Galvinoxyl/BHT Added Experiment (in the Compound 4aa Synthesis)

An oven dried 25 mL Schlenk tube was charged with 1a (0.037 g, 0.203 mmol), KO^{t}Bu (0.034 g, 0.304 mmol), TEMPO (0.063 g, 0.403 mmol) [or Galvinoxyl (0.169 g, 0.401 mmol) or BHT (0.089, 0.404 mmol)], Ni-1 (0.003 g, 0.01 mmol, 5 mol %), 2a (0.077 g, 0.71 mmol), and toluene (1 mL) inside the glove box. The tube was sealed by a glass stopper and the resultant reaction mixture in the tube was immersed in preheated oil bath at 130° C. and stirred for 24 h. At ambient temperature, the reaction mixture was diluted with EtOAc and filtered through filter paper. Then, the volatiles were removed under vacuo and dried. The ¹H NMR analysis indicated 54% formation of 3aa in case of TEMPO and 23% of 3aa in case of BHT and shows no product formation in case of galvinoxyl. The formation of product 4aa was not observed.

### Advantages of the Invention

Simple, efficient and easy to handle Ni based catalyst
Provides simple hydrogenating and dehydrogenating reactions using said Ni based catalyst
In this catalysis, single Ni based catalyst act as dual acting catalyst providing two different products (imine and amine), and no other nickel catalyst is reported showing the dual selectivity.
In the synthesis of imine, only H₂O is the by-product during the reaction, and avoids the liberation of H₂.
Said catalyst with the hydroxyl group substitution on one of pyridine ring works efficiently without any other photocatalyst.
It enables to tune the reactivity of catalyst by changing the conditions and obtained formation of imine in presence of K2CO3 as base, and amine in presence of KOtBu base.

We claim:

1. A nickel-based catalyst of formula (I) 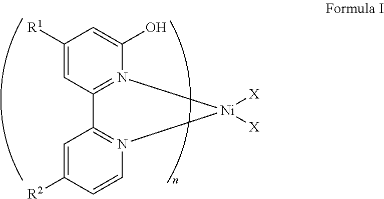
wherein,
n=1 or 2;
R¹ is selected from hydrogen, C1-C4 alkyl and aryl;
R² is selected from hydrogen, C1-C4 alkyl and aryl; and
X is selected from halogen, —OCO-alkyl, —OAc or —OTf;
wherein
the aryl of R¹ and/or R² is phenyl which may be further substituted with any of group selected from C1-C4 alkyl, aryl, alkoxy, halo, —OTf, —OCO— alkyl and —OAc; the alkyl connected to —OCO— is C1-C4 alkyl; and
the halogen is selected from chloro, iodo, bromo and fluoro.

2. The catalyst as claimed in claim 1, wherein the catalyst is useful for hydrogenation-dehydrogenation coupling reactions and secondary imine hydrogenation reactions.

3. A process of preparation of nickel-based catalyst of formula (I) as claimed in claim 1 comprising steps of:
a) adding dimethoxy ethane nickel compound of formula II with hydroxy bipyridine compound of formula III in presence of a solvent under inert atmosphere in a round bottom glass flask to obtain a mixture; 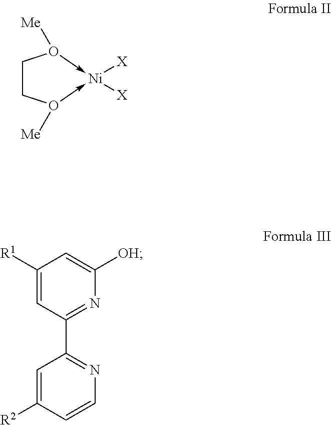
wherein the R¹, R² and X are same as defined in claim 1;
b) stirring the mixture as obtained in step a) at a temperature in the range of 25 to 60° C. for a time period of 12-24 hrs to obtain a stirred reaction mixture;
c) evaporating and drying the reaction mixture as obtained in step b) to obtain the catalyst of formula I; and
d) optionally, purifying the catalyst to obtain the catalyst of formula I.

4. The process as claimed in claim 3, wherein the solvent used in step a) is selected from the group consisting of methanol, ethanol, toluene and THF.

5. The process as claimed in claim 3, wherein the evaporation and drying in step c) is done by first evaporating solvent in vacuo to obtain solid product, followed by washing with diethyl ether, and subsequent drying under vacuum provided the catalyst of formula I.

6. A process of hydrogenation-dehydrogenation coupling reaction using catalyst of formula (I) as claimed in claim 1, the process comprising steps of:
a) reacting azobenzene of formula IV with (un)substituted benzyl alcohol of formula V in presence of 0.001 to 0.05 mmol of the catalyst of formula (I) as claimed in claim 1, a base and a solvent in a tube to obtain a reaction mixture; 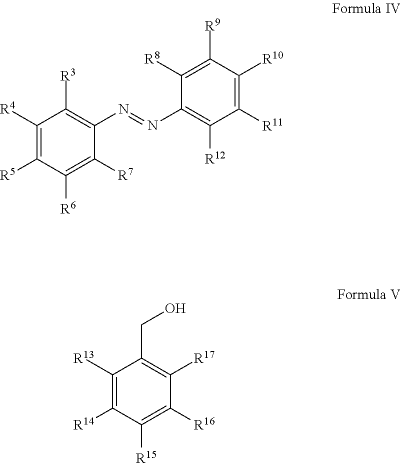
wherein
R3: hydrogen, alkyl, halogen and cycloalkyl;
R4: hydrogen, alkyl, alkoxy, halogen and cycloalkyl;
R5: hydrogen, alkyl, alkoxy, sulphonyl alkyl, —OCF3, —SMe, —SMe2, aminoalkyl, —CF3, —OCHF2, —COO-alkyl, halogen;
6: hydrogen, alkyl, alkoxy, and halogen;
R7: hydrogen, alkyl, halogen and cycloalkyl;
R8: hydrogen, alkyl, halogen and cycloalkyl;
R9: hydrogen, alkyl, alkoxy, halogen and cycloalkyl;
R10: hydrogen, alkyl, alkoxy, sulphonyl alkyl, aminoalkyl, amino, —CF3, —OCF3, —OCHF2, —COO-alkyl, halogen;
R11: hydrogen, alkyl, alkoxy, halogen and cycloalkyl;
R12: hydrogen, alkyl, halogen and cycloalkyl;
R13: hydrogen, alkyl, alkoxy, —CF3 and cycloalkyl;
R14: hydrogen, alkyl, alkoxy, —CF3, halogen and cycloalkyl;
R15: hydrogen, alkyl, alkoxy, sulphonyl alkyl, —O-aryl, —OCF3, —CF3, —SMe, —SMe2, halogen;
R16: hydrogen, alkyl, alkoxy, —CF3, halogen and cycloalkyl; and
R17: hydrogen, alkyl, alkoxy, —CF3 and cycloalkyl;
b) heating the reaction mixture obtained in step a) at a temperature in the range of 120-150° C. for a time period in the range of 16 to 24 h to obtain a hot reaction mixture; and
c) cooling the hot reaction mixture obtained in step b) to an ambient temperature in the range of 25-35° C. followed by filtration to obtain the (un)substituted of (E)-N,1-diphenylmethanimine compounds of Formula IIa and/or IIb 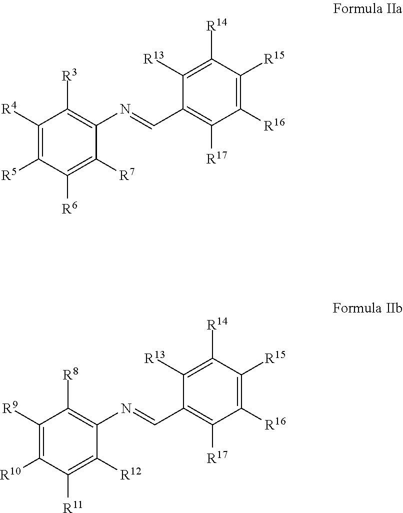
wherein R³, R⁴, R₅, R⁶, R⁷, R⁸, R⁹, R¹⁰, R¹¹, R¹², R¹³, R¹⁴, R¹⁵, R¹⁶ and R¹⁷ is same as defined above, optionally R¹⁵ and R¹⁶ together forms a cyclic ring selected from aryl or heteroaryl ring.

7. The process as claimed in claim 6, wherein the base is selected from the group consisting of potassium carbonate (K₂CO₃), potassium tertiary butoxide (KtOBu) and Tripotassium phosphate (K₃PO₄).

8. A process of secondary imine hydrogenation reaction using catalyst of formula (I) as claimed in claim 1, the process comprising steps of:
a) reacting azobenzene of formula IV with (un)substituted benzyl alcohol of formula V in presence of 0.001 to 0.05 mmol of the catalyst of formula (I) as claimed in claim 1, a base, and a solvent in a tube to obtain a reaction mixture; 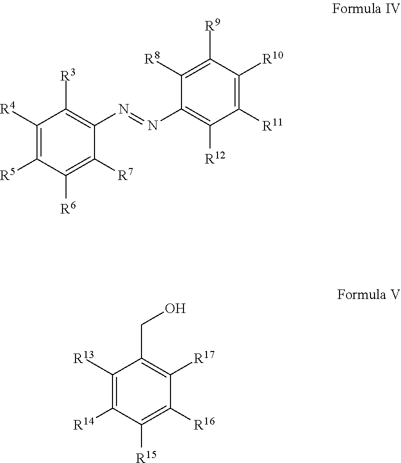
wherein
R3: hydrogen, alkyl, halogen and cycloalkyl;
R4: hydrogen, alkyl, alkoxy, halogen and cycloalkyl;
R5: hydrogen, alkyl, alkoxy, sulphonyl alkyl, —OCF3, —SMe, —SMe2, aminoalkyl, —CF3, —OCHF2, —COO-alkyl, and halogen;
R6: hydrogen, alkyl, alkoxy, halogen and cycloalkyl;
R7: hydrogen, alkyl, halogen and cycloalkyl;
R8: hydrogen, alkyl, halogen and cycloalkyl;
R9: hydrogen, alkyl, alkoxy, halogen and cycloalkyl;
R10: hydrogen, alkyl, alkoxy, sulphonyl alkyl, aminoalkyl, amino, —CF3, —OCF3, —OCHF2, —COO-alkyl, halogen;
R11: hydrogen, alkyl, alkoxy, halogen and cycloalkyl;
R12: hydrogen, alkyl, halogen and cycloalkyl;
R13: hydrogen, alkyl, alkoxy, —CF3 and cycloalkyl;
R14: hydrogen, alkyl, alkoxy, —CF3, halogen and cycloalkyl;
R15: hydrogen, alkyl, alkoxy, sulphonyl alkyl, —O-aryl, —OCF3, —CF3, —SMe, —SMe2, and halogen;
R16: hydrogen, alkyl, alkoxy, —CF3, halogen and cycloalkyl; and
R17: hydrogen, alkyl, alkoxy, —CF3 and cycloalkyl;
b) heating the reaction mixture to a temperature in the range of 120-150° C. for a time period of 16-24 h to obtain a hot reaction mixture; and
c) cooling the hot reaction mixture as obtained in step (b) to room temperature in the range of 25-35° C. followed by filtration to obtain the (un)substituted N-benzylaniline of formula IIIa and/or IIIb 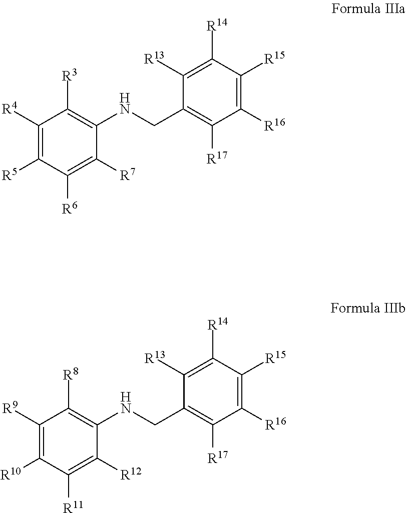
wherein R³, R⁴, R⁵, R⁶, R⁷, R⁸, R⁹, R¹⁰, R¹¹, R¹², R¹³, R¹⁴, R¹⁵, R¹⁶ and R¹⁷ is same as defined above, optionally R¹⁵ and R¹⁶ together forms a cyclic ring selected from aryl or heteroaryl ring.

9. The process as claimed in claim 8, wherein the base is selected from potassium bis(trimethylsilyl)amide (KHMDS) and potassium tertiary butoxide (KtOBu).

10. The process claimed in claim 6 or 8, wherein in the compound of formulas IIa, IIb, IIIa, IIIb, IV and V, the alkyl is selected from C1-C6 alkyl; halogen is selected from chloro, bromo, fluoro and iodo; the alkyl in alkoxy, sulphonyl alkyl, aminoalkyl and —COO-alkyl groups is selected from C1-C4 alkyl; and the aryl in O-aryl is selected from substituted or unsubstituted aryl.

11. The process claimed in claim 6 or 8, wherein the solvent is selected from the group consisting of toluene, o-xylene, m-xylene, and p-xylene.
